(19) United States
(12) Patent Application Publication
(10) Pub. No.: US 2024/0399332 A1
(43) Pub. Date: Dec. 5, 2024

(54) Vortex Reactor

(71) Applicant: Government of the United States, as represented by the Secretary of the Air Force, Wright-Patterson AFB, OH (US)

(72) Inventors: Matthew N. Fuqua, Oakwood, OH (US); Connor J. Wiese, Bellefonte, PA (US); James L. Rutledge, Beavercreek, OH (US)

(21) Appl. No.: 18/226,457

(22) Filed: Jul. 26, 2023

Related U.S. Application Data
(60) Provisional application No. 63/470,289, filed on Jun. 1, 2023.

(51) Int. Cl. B01J 19/00; B01J 15/00; B01J 19/24

(52) U.S. Cl. CPC B01J 19/0053; B01J 15/005; B01J 19/2415; B01J 2219/00121; B01J 2219/2419

(57) ABSTRACT

The present invention relates to vortex reactors, articles comprising vortex reactors, and processes of making and using vortex reactors as well as articles comprising vortex reactors. Such vortex reactors comprise vortex tube and a vortex tube inner component that catalyzes a desired reaction or cracking that surprisingly does not substantially increase vortex tube back pressure. Such vortex reactor provides a surprising and unexpected increase in reaction and cracking efficiencies and can be used for systems that are exothermic or endothermic.

### CROSS-REFERENCE TO RELATED APPLICATION

The present application claims priority to U.S. Provisional Application Ser. No. 63/470,289 filed Jun. 1, 2023, the contents of such priority document being hereby incorporated by reference in its entry.

### RIGHTS OF THE GOVERNMENT

The invention described herein may be manufactured and used by or for the Government of the United States for all governmental purposes without the payment of any royalty.

### FIELD OF THE INVENTION

The present invention relates to vortex reactors, articles comprising vortex reactors, and processes of making and using vortex reactors as well as articles comprising vortex reactors.

### BACKGROUND OF THE INVENTION

A vortex tube is a device which separates a single stream of high pressure gas into two streams: one of higher temperature than the input stream and one of lower temperature. Gas is injected tangentially into the device to induce a strong swirling motion in the flow. The device has no moving parts and depends exclusively on the behavior of high pressure fluids with a vortical flow structure. Such a flow exhibits a temperature separation phenomenon in which the high velocity fluid in the outer layers of the vortex achieves a high temperature while conversely the slower inner core of the vortex is brought to a low temperature. A vortex tube design exploits this temperate gradient by exhausting the cooler vortex core through an orifice at one end while exhausting the hotter outer region through a radial opening at the opposite end. Using only compressed air, commercially available vortex tubes can produce cold-side temperatures as low as −50° F. and hot-side temperatures as high as 260° F. As a result, vortex tubes are used in applications, such as spot cooling in machine shops, cabinet cooling, personal air conditioning, and gas separation.

While vortex tubes can produce hot-side temperatures as high as 260° F., such hot-side temperatures are generally too low to react or crack certain materials. As a result, adding external heat energy has been proposed. Unfortunately, the mere addition of heat energy to a vortex tube has not resulted in the reaction or cracking efficiency that is required.

Applicants recognized that the source of reaction or cracking efficiency problem had two major components, a rate limitation and a back pressure limitation. In view of such limitation set, Applicants developed a vortex tube inner component that catalyzes a desired reaction or cracking that surprisingly does not substantially increase vortex tube back pressure. The combination of the aforementioned vortex tube and vortex tube inner component yields a vortex reactor that provides a surprising and unexpected increase in reaction and cracking efficiencies. Such vortex reactor can be used for systems that are exothermic or endothermic.

### SUMMARY OF THE INVENTION

The present invention relates to vortex reactors, articles comprising vortex reactors, and processes of making and using vortex reactors as well as articles comprising vortex reactors. Such vortex reactors comprise vortex tube and a vortex tube inner component that catalyze a desired reaction or cracking that surprisingly does not substantially increase vortex tube back pressure. Such vortex reactor provides a surprising and unexpected increase in reaction and cracking efficiencies and can be used for systems that are exothermic or endothermic.

Additional objects, advantages, and novel features of the invention will be set forth in part in the description which follows, and in part will become apparent to those skilled in the art upon examination of the following or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated in and constitute a part of this specification, illustrate embodiments of the present invention and, together with a general description of the invention given above, and the detailed description of the embodiments given below, serve to explain the principles of the present invention.

FIG. 1 is a side view of the vortex tube having outer tube (1) with tangential inlets (2) adjacent to the cold exit (3), with fins (4) protruding from the interior wall of the tube, and with a cone-shaped central obstruction (5) adjacent to the hot exit (6).

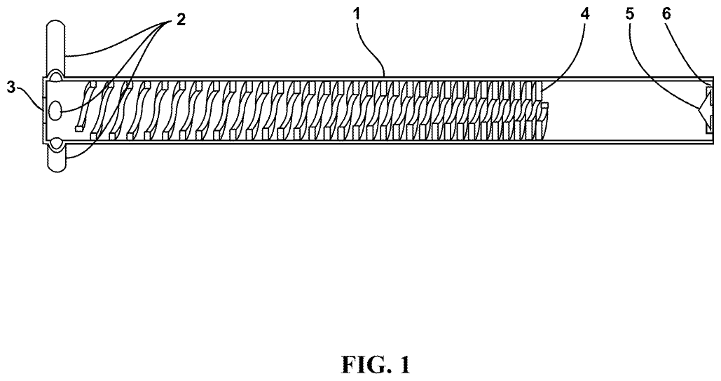

FIG. 2 is an isometric view of the vortex tube illustrating the outer tube (1), the tangential inlets (2), the cone-shaped central obstruction (3) affixed by radial spokes (4) adjacent to the hot exit (5).

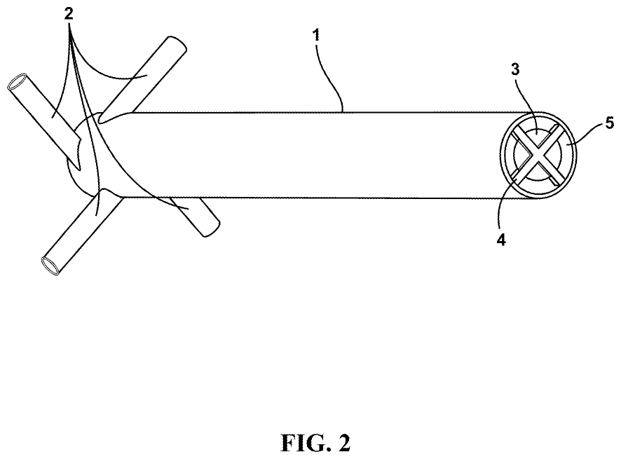

FIG. 3 is an isometric view of the vortex tube illustrating the tube (1), the tangential inlets (2), and the cold exit orifice (3).

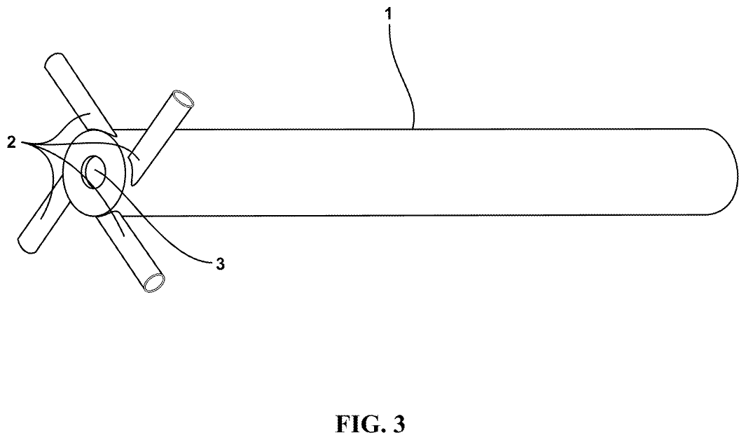

It should be understood that the appended drawings are not necessarily to scale, presenting a somewhat simplified representation of various features illustrative of the basic principles of the invention. The specific design features of the sequence of operations as disclosed herein, including, for example, specific dimensions, orientations, locations, and shapes of various illustrated components, will be determined in part by the particular intended application and use environment. Certain features of the illustrated embodiments have been enlarged or distorted relative to others to facilitate visualization and clear understanding. In particular, thin features may be thickened, for example, for clarity or illustration.

### DETAILED DESCRIPTION OF THE INVENTION

### Definitions

Unless specifically stated otherwise, as used herein, the terms “a”, “an” and “the” mean “at least one”.

As used herein, the terms “include”, “includes” and “including” are meant to be non-limiting.

As used herein, the words “about,” “approximately,” or the like, when accompanying a numerical value, are to be construed as indicating a deviation as would be appreciated by one of ordinary skill in the art to operate satisfactorily for an intended purpose.

As used herein, the words “and/or” means, when referring to embodiments (for example an embodiment having elements A and/or B) that the embodiment may have element A alone, element B alone, or elements A and B taken together.

Unless otherwise noted, all component or composition levels are in reference to the active portion of that component or composition, and are exclusive of impurities, for example, residual solvents or by-products, which may be present in commercially available sources of such components or compositions.

All percentages and ratios are calculated by weight unless otherwise indicated. All percentages and ratios are calculated based on the total composition unless otherwise indicated.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

### Vortex Reactor and Articles Comprising Same

For purposes of this specification, headings are not considered paragraphs. In this paragraph, Applicants disclose a vortex reactor comprising: a vortex tube, said vortex tube having a radius and comprising an exterior surface, an interior surface a first side and a second side, said first side comprising one or more tangential fluid inputs, and one or more cool temperature fluid exits, said second side comprising one or warm fluid exits, a fluid flow path through said vortex tube and optionally a center divider that protrudes at least partially into at least one warm fluid exit; and one or more vortex tube inner components, said one or more vortex tube inner components comprising a catalytic material.

In this paragraph, Applicants disclose a vortex reactor according to the previous paragraph wherein said catalytic material is selected from the group consisting of nickel, ruthenium, molybdenum, alumina, carbon, iron, and mixtures thereof, preferably said catalytic material is selected from the group consisting of nickel and alumina and mixtures thereof.

In this paragraph, Applicants disclose a vortex reactor according to the previous two paragraphs comprising: from about one to about ten tangential fluid inputs, preferably from about three to about seven tangential fluid inputs, most preferably from about four to about six tangential fluid inputs: from about one to about ten cool temperature fluid exits, preferably from about one to about four cool temperature fluid exits, more preferably from about one to about two cool temperature fluid exits: from about one to about ten warm temperature fluid exits, preferably from about one to about four warm temperature fluid exits; said optional center divider divides a flow through said fluid flow path into one to ten axially oriented streams, or one to ten radially oriented streams, or a combination thereof: optionally one or more inward facing helical fins, each inward facing helical fin independently having fixed or variable pitch, a fixed or variable thickness a fixed or variable height, and/or cross section that is rectangular, triangular, polygonal, or rounded, preferably said cross section is rectangular: preferably said one or more optional inward facing helical fins are aligned with a fluid flow path in said vortex reactor, said fluid flow path being bounded by a distance of between zero and one vortex tube radius.

In this paragraph, Applicants disclose a vortex reactor according to the previous three paragraphs wherein said vortex tube is tapered.

In this paragraph, Applicants disclose a vortex reactor according to the previous four paragraphs wherein said center divider comprises a porous or nonporous cylinder, said cylinder tube spanning all or part of the length of said vortex reactor and being positioned in said vortex reactor without contacting an inner wall of said vortex reactor, said cylinder being a solid or a tube, preferably said cylinder comprises one or more inward facing helical fins, each inward facing helical fin independently having fixed or variable pitch, a fixed or variable thickness a fixed or variable height, and/or cross section that is rectangular, triangular, polygonal, or rounded, preferably said cross section is rectangular: preferably said one or more optional inward facing helical fins are aligned with a fluid flow path in said vortex reactor, said fluid flow path being bounded by a distance of between zero and one vortex tube radius. The cylinder if hollow can contain a fluid flow, an electrical resistive heating apparatus, a combustion product and/or combustion products.

In this paragraph, Applicants disclose a vortex reactor according to the previous five paragraphs comprising an interior surface at least a portion of said interior surface comprising a catalytic material.

In this paragraph, Applicants disclose an article comprising a vortex reactor according to the previous six paragraphs, said article being a turbine engine, a reciprocating engine or a heat exchanger. In one aspect, the vortex reactor routes hot, cold, or both exhaust streams to a combustion device. The flow through the exhaust streams may be controlled to adjust the relative fraction of the inlet flow rate that is exhausted from either exit. The streams may be partially or completely mixed to achieve a desired blend of the exhaust products. In one aspect, the vortex reactor is incorporated into a heat exchanger installed in a gas turbine engine in the exhaust stream downstream of the turbine stage whereby waste heat is transferred into the device to enable catalysis of the ammonia working fluid flowing through the vortex tube. In one aspect, the vortex reactor is incorporated into the interior passages of hollow, cooled turbine blades in a gas turbine engine such that the endothermic decomposition reaction of ammonia catalyzed by the vortex tube permits cooling of the turbine blade. In one aspect, the turbine engine may be incorporated into the power generation or propulsion architecture of a ground-based vehicle or power plant. The turbine engine may be incorporated into the power generation or propulsion architecture of a marine-based vehicle or power plant. The turbine engine may be incorporated into the power generation or propulsion architecture of an air vehicle or power plant. In one aspect, the vortex reactor is incorporated into the hot exhaust of a reciprocating engine whereby waste heat is transferred into the device to enable catalysis of the ammonia working fluid flowing through the vortex tube. The reciprocating engine may be incorporated into the power generation or propulsion architecture of a ground-based vehicle or power plant. The reciprocating engine may be incorporated into the power generation or propulsion architecture of a marine-based vehicle or power plant. The reciprocating engine may be incorporated into the power generation or propulsion architecture of an air vehicle or power plant. In one aspect, the vortex reactor is incorporated into the cooling and thermal management architecture of air vehicles such that the endothermic cracking reaction of ammonia catalyzed by the vortex tube absorbs localized heat generation related to electrical resistance heating, aerodynamic heating, or other excess heat generation. In one aspect, the vortex reactor is incorporated into the cooling and thermal management architecture of terrestrial or marine power generation such that the endothermic cracking reaction of ammonia catalyzed by the vortex tube absorbs localized heat generation related to electrical resistance heating, solar heating, chemical reactions, combustion, or action of radioisotopes, or other excess heat generation.

### Process of Using Vortex Reactor

Applicants disclose a process of conducting a catalytic reaction using a vortex reactor according to any of the paragraphs one through six of the section of this specification titled “Vortex Reactor and Articles Comprising Same”, said process comprising injecting a fluid to be catalytically reacted in one or more tangential fluid inputs of the vortex reactor, said fluid having a temperature and being injected under a pressure into said vortex reactor.

In this paragraph, Applicants disclose a process according to the previous paragraph wherein said fluid is heated in said vortex reactor by a heat source that is generated by said vortex tube's internal fluid energy transfer and/or by a heating source that is an internal vortex tube heating device and/or an external vortex tube heating device.

In this paragraph, Applicants disclose a process according to the previous two paragraphs wherein said fluid injection pressure is from about 0.1 bar to about 100 bar and/or said fluid injection temperature is from about minus 30° C. to about 1200° C. In one aspect, the fluid injection pressure is from about 3 bar to about 7 bar. As the pressure increases, the temperature of the hot stream in the vortex reactor increases.

In this paragraph, Applicants disclose a process according to the previous three paragraphs wherein said injected fluid is comprises ammonia, said fluid injection pressure is from about 3 bar to about 7 bar, said fluid temperature of said ammonia when said ammonia is injected into said one or more tangential fluid inputs of the vortex reactor is from about 200° C. to 1200° C. and said vortex reactor catalytic material is selected from the group consisting of nickel and alumina and mixtures thereof.

Materials that are needed to produce and use the subject vortex reactor can be obtained as follows: ammonia decomposition catalyst Katalco™ 27-2 (a nickel-alumina based catalyst) can be purchased from Johnson Matthey in London, UK; Inconel® 718, i.e., alloy UNS N07718, can be purchased in powder form from Carpenter Technology (Philadelphia, PA) and Molybdenum can be purchased in powder form from Tekna (Sherbrouke, Quebec).

### Examples

The following examples illustrate particular properties and advantages of some of the embodiments of the present invention. Furthermore, these are examples of reduction to practice of the present invention and confirmation that the principles described in the present invention are therefore valid but should not be construed as in any way limiting the scope of the invention.

Example 1: Vortex Reactor Construction and Use. A vortex tube having a diameter of 10 millimeters and a length of 100 millimeters, four tangential inlets spaced in equal circumferential increments adjacent to one end, i.e., axial extent, of the tube is 3D printed using a X Line 2000R printer (GE Additives of Cincinnati, Ohio, USA) from Inconel® 718. At the same axial end of the tube as the inlets, the tube features a central orifice of diameter 4 millimeters, align to the tube central axis: the is the cold exit orifice. At the opposite end of the vortex tube from the tangential inlets and axial cold exit orifice, i.e., at the maximum axial extent, the vortex tube features a central obstruction in the shape of a cone aligned to the tube central axis and inserted two millimeters into the hot exit such that the hot exit forms an annular exit. The cone-shaped central obstruction has a half-angle of sixty degrees and has a maximum diameter of six millimeters. The cone is held in place by four radial spokes, positioned with equal circumferential spacing. The radial spokes have a square-shaped cross section with a side length of one millimeter and connect the central cone-shaped obstruction with the outer tube wall. From the inner surface of the tube, two helical fins extend inward. The helical fins are equally spaced circumferentially and have a cross section that is rectangular with rounded corners. Axially, the fins extend the partial length of the tube beginning at an axial position of 5 millimeters (distant from the cold exit orifice) and terminating at an axial position of 70 millimeters. The fins vary in height, thickness, and pitch along their axial extent, varying linearly from an initial height of 1.0 millimeter, thickness of 1 millimeter, and pitch of 5.6 millimeters to a final height of 3.0 millimeters, thickness of 0.8 millimeters, and pitch of 3.0 millimeters. The exposed surface of the inner tube wall of the vortex tube and the helical structure are coated with nickel-alumina catalyst Katalco™ 27-2, which can be purchased from Johnson Matthey in London, England. The working fluid in the vortex tube is anhydrous, gaseous ammonia, which is injected into the vortex tube via the inlets at a temperature of 900° C. and a pressure of 5 bar absolute and undergoes thermocatalytic decomposition, i.e., cracking to produce gaseous hydrogen and gaseous nitrogen: the gaseous hydrogen and gaseous nitrogen and/or uncracked ammonia are exhausted at the ends of the tube, i.e., via the hot and cold exits. Vortex reactor tubing and valving is used to route the gaseous hydrogen and gaseous nitrogen and/or uncracked ammonia to a combustion device. The flow through the exhaust streams may be controlled to adjust the relative fraction of the inlet flow rate that is exhausted from either exit. The streams may be partially or completely mixed to achieve a desired blend of the exhaust products. The gaseous hydrogen and/or uncracked ammonia are then burned as a fuel in said combustion device.

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While the present invention has been illustrated by a description of one or more embodiments thereof and while these embodiments have been described in considerable detail, they are not intended to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the scope of the general inventive concept.

What is claimed is:

1. A vortex reactor comprising:
a) a vortex tube, said vortex tube having a radius and comprising an exterior surface, an interior surface a first side and a second side, said first side comprising one or more tangential fluid inputs, and one or more cool temperature fluid exits, said second side comprising one or warm fluid exits, a fluid flow path through said vortex tube and optionally a center divider that protrudes at least partially into at least one warm fluid exit; and
b) one or more vortex tube inner components, said one or more vortex tube inner components comprising a catalytic material.

2. The vortex reactor of claim 1 wherein said catalytic material is selected from the group consisting of nickel, ruthenium, molybdenum, alumina, carbon, iron, and mixtures thereof.

3. The vortex reactor of claim 1 wherein, said catalytic material is selected from the group consisting of nickel and alumina and mixtures thereof.

4. The vortex reactor of claim 1 comprising:
a) from about one to about ten tangential fluid inputs;
b) from about one to about ten cool temperature fluid exits;
c) from about one to about ten warm temperature fluid exits;
d) said optional center divider dividing a flow through said fluid flow path into one to ten axially oriented streams, one to ten radially oriented streams, or a combination thereof;
e) optionally one or more inward facing helical fins, each inward facing helical fin independently having a fixed or variable pitch, a fixed or variable thickness a fixed or variable height, and/or cross section that is rectangular, triangular, polygonal, or rounded.

5. The vortex reactor of claim 4 comprising:
a) from about three to about seven tangential fluid inputs;
b) from about one to about four cool temperature fluid exits;
c) from about one to about four warm temperature fluid exits;
d) said optional center divider dividing a flow through said fluid flow path into one to ten axially oriented streams, one to ten radially oriented streams, or a combination thereof;
e) optionally one or more inward facing helical fins, each inward facing helical fin independently having a fixed or variable pitch, a fixed or variable thickness a fixed or variable height, and/or cross section that is rectangular: preferably said one or more optional inward facing helical fins being aligned with a fluid flow path in said vortex reactor, said fluid flow path being bounded by a distance of between zero and one vortex tube radius.

6. The vortex reactor of claim 5 comprising:
a) from about four to about six tangential fluid inputs; and
b) from about one to about two cool temperature fluid exits.

7. The vortex reactor of claim 1 wherein said vortex tube is tapered.

8. The vortex reactor of claim 1 wherein said center divider comprises a porous or nonporous cylinder, said cylinder tube spanning all or part of the length of said vortex reactor and being positioned in said vortex reactor without contacting an inner wall of said vortex reactor, said cylinder being a solid or a tube.

9. The vortex reactor of claim 8 wherein said cylinder comprises one or more inward facing helical fins, each inward facing helical fin independently having fixed or variable pitch, a fixed or variable thickness a fixed or variable height, and/or cross section that is rectangular, triangular, polygonal, or rounded, and said one or more optional inward facing helical fins are aligned with a fluid flow path in said vortex reactor, said fluid flow path being bounded by a distance of between zero and one vortex tube radius.

10. The vortex reactor of claim 9 wherein said cylinder comprises one or more inward facing helical fins, each inward facing helical fin independently having fixed or variable pitch, a fixed or variable thickness a fixed or variable height, and/or cross section that is rectangular; and said one or more optional inward facing helical fins are aligned with a fluid flow path in said vortex reactor, said fluid flow path being bounded by a distance of between zero and one vortex tube radius

11. A vortex reactor according to claim 1 comprising an interior surface at least a portion of said interior surface comprising a catalytic material.

12. An article comprising the vortex reactor of claim 1, said article being a turbine engine, a reciprocating engine or a heat exchanger.

13. A process of conducting a catalytic reaction, said process comprising injecting a fluid to be catalytically reacted in one or more tangential fluid inputs of the vortex reactor of claim 1, said fluid having a temperature and being injected under a pressure into said vortex reactor.

14. The process of claim 13 wherein said fluid is heated in said vortex reactor by a heat source that is generated by said vortex tube's internal fluid energy transfer and/or by a heating source that is an internal vortex tube heating device and/or an external vortex tube heating device.

15. The process of claim 13 wherein said fluid injection pressure is from about 0.1 bar to about 100 bar and/or said fluid injection temperature is from about minus 30° C. to about 1200° C.

16. The process of claim 15 wherein said fluid injection pressure is from about 0.1 bar to about 100 bar.

17. The process of claim 13 wherein said injected fluid is comprises ammonia, said fluid injection pressure is from about 3 bar to about 7 bar, said fluid temperature of said ammonia when said ammonia is injected into said one or more tangential fluid inputs of the vortex reactor is from about 200° C. to 1200° C. and said vortex reactor catalytic material is selected from the group consisting of nickel and alumina and mixtures thereof.
